(19) United States
(12) Patent Application Publication
(10) Pub. No.: US 2018/0260537 A1
(43) Pub. Date: Sep. 13, 2018

(54) AT-LAUNCH CONFIGURATION OF SOFTWARE APPLICATIONS

(71) Applicant: Microsoft Technology Licensing, LLC, Redmond, WA (US)

(72) Inventors: Atin Pramodkumar Malik, Seattle, WA (US); Sinduja Ramanujam, Redmond, WA (US); Harold E. Beyel, III, Bellevue, WA (US)

(21) Appl. No.: 15/456,314

(22) Filed: Mar. 10, 2017

(51) Int. Cl. G06F 21/10; G06F 9/445; H04L 9/32

(52) U.S. Cl. CPC G06F 21/105; G06Q 2220/18; H04L 9/32; G06F 8/61

(57) ABSTRACT

Systems, methods, and software are disclosed herein to perform at-launch software configuration based on software license. In an implementation, a software installation package, including a software application and a set of license files, is downloaded onto a computing system. The software application is installed and the set of the license files is stored, but not installed. The software application is launched. During the launch of the software application, an authentication key for the software application is retrieved. After retrieving the authentication key, a license is selected from the set of license files that were downloaded, but not installed, prior to launching the software application. The license file is installed on the computing system and unlocked with the authentication key. After installing and unlocking the license file, the software application is configured based on the license file.

### TECHNICAL BACKGROUND

Software applications are computer programs designed to perform a group of coordinated functions. Software applications or end-user programs include database programs, word processing, accounting, and spreadsheet applications, web browsers, etc. Many software applications are offered in multiple editions (i.e. student and professional editions). The different editions may offer a different set of features. Some of the features between the editions may overlap, but others may be offered only in their respective edition. A user typically purchases a software license for use of a software application. Application features are enabled or disabled based on the license purchased by a user.

An “activation” process is often completed to install a copy of a software application. The activation process involves the user downloading a software installation package for the particular edition that corresponds to the license purchased by the user. In the past, if a user purchased a new license for a different edition of the software, a new software installation package would need to be downloaded and installed.

### OVERVIEW

Technology is disclosed herein for that allows for software to be configured at launch time based on a software license. In an implementation, a software package, including a software application and a set of license files, is downloaded onto a computer system. The software application is installed and the set of the license files is stored, but not installed. The application is subsequently launched, at which time, an authentication key for the software application is retrieved. After retrieving the authentication key, a license is selected from the set of license files that were downloaded, but not installed, prior to the launch of the software application. The license file is installed and unlocked with the authentication key. After installing and unlocking the license file, the software application is configured based on the license file.

The foregoing Overview is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates an implementation of at-launch configuration of a software application.

FIG. 2 illustrates a flow diagram illustrating example operations of the launch-based configuration of the software application.

FIG. 3 illustrates a flow diagram illustrating example operations of the at-launch configuration of the software application.

FIG. 4 illustrates a sequence diagram illustrating example operations of the at-launch configuration of the software application.

FIG. 5 illustrates another implementation of at-launch configuration of a software application.

FIG. 6 illustrates a sequence diagram illustrating example operations of the at-launch configuration of the software application.

FIG. 7 illustrates an operational scenario for an at-launch configuration of a software application.

FIG. 8 illustrates a computing system suitable for implementing the software technology disclosed herein, including any of the applications, architectures, elements, processes, and operational scenarios and sequences illustrated in the Figures and discussed below in the Technical Disclosure.

### TECHNICAL DISCLOSURE

Technology is disclosed herein for at-launch software configuration based on software license, which may sometimes be referred to as just-in-time (JIT) configuration. In an implementation, a software installation package, including a software application and a set of license files, is downloaded onto a computer system. The software application is installed and the set of the license files is stored, but not installed. The software application is subsequently launched and, during the launch of the software application, an authentication key for the software application is retrieved. After retrieving the authentication key, a license is selected from the set of license files that were downloaded, but not installed, prior to the launch of the software application. The license file is installed and unlocked with the authentication key. After installing unlocking the license file, the software application is configured based on the license file.

A technical effect provided by the technology disclosed herein is the ability to perform at-launch configuration of a software application. More specifically, the technology allows features of the software application to be enabled and disabled based on a user's license(s) at the time the software application is launched, eliminating the need to download and re-install a software installation package each time the license changes. This may be applicable when, for example, a user upgrades from a student edition to a professional edition, or when multiple users, each with a different license, share a computing system.

In general, a software application may have multiple editions with different capabilities or features. The technology disclosed herein allows the multiple editions of a software application to be supported by the same deployment package. Product functionality (features) may be dictated by the license. One or more licenses may be used to determine the software application's capability (enabled features). The software application is dynamically configured to enable/disable the features based on the license. This allows for a single installation package (all features across all editions), which simplifies deployment and installation.

In some implementations, a user may have purchased multiple licenses. For example, a user may have a home edition associated with a home computer and a professional edition associated with a work computer. The invention allows the user to access the professional edition of the software application while using the home computer without requiring re-install of the software application.

For example, the user may use her work login information on her home computer. When the user launches the software application, an authentication key for the software application is retrieved. After retrieving the authentication key, a license is selected from the set of license files that were downloaded, but not installed, prior to the launch of the software application. The license file may be selected based on the user's login. Since the user is logged in with her work login credentials, the user is licensed for the professional edition of the software application and the corresponding license file is selected. The professional license file is installed and unlocked with the authentication key. After installing unlocking the license file, the software application is configured based on the professional license file.

In another example, a user may purchase a new license. Rather than having to download and install a new version of the application associated with the new license, a corresponding license file that was already downloaded (but not installed) may be unlocked and installed using a new authentication key.

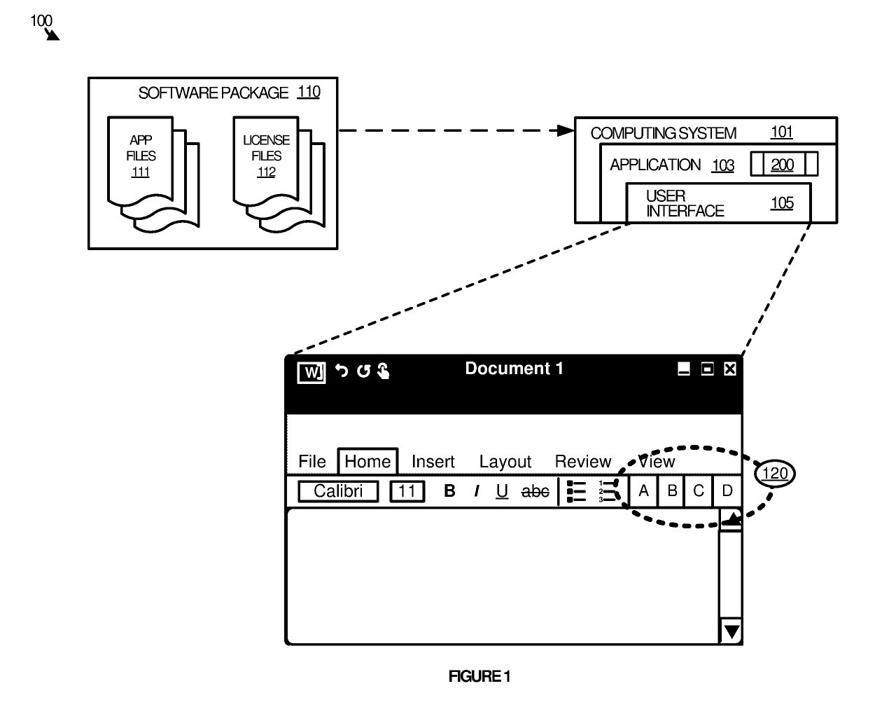

FIG. 1 illustrates an implementation 100 that is representative of at-launch (just-in-time) configuration of software application 103. Implementation 100 involves software package 110, which includes application files 111 and license files 112 being downloaded onto computing system 101. Software package 110 may be the software installation package for application 103. Application files 111 are downloaded and installed onto computing system 101. License files 112 are downloaded, but not installed.

After downloading and installing application files 111, application 103 may be run on computing system 101. When executing, application 103 drives user interface 105 through which a user may interact with application 103. FIG. 1 illustrates an instance of application 103. As shown, application 103 has a configuration 120, which includes features A-D enabled.

Application 103 is representative of any software application that is suitable for at-launch configuration. Examples include, but are not limited to, spreadsheet applications, word processing applications, presentation applications, email applications, social networking applications, gaming applications, video or image editing applications, business applications, productivity applications, database applications, and any other type of software application—including any combination or variation thereof. Application 103 may be implemented as a natively installed and executed application, a server-based application, a browser-based application, a streaming or streamed application, a mobile application, or any other suitable manner.

In operation, software package 110 is downloaded onto computer system 101. The application files 111 are installed onto computing system 101, and license files 112 are stored, but not installed. A user may launch application 103. During the launch of application 103, an authentication key for application 103 is retrieved. After retrieving the authentication key, a license is selected from license files 112 that were downloaded, but not installed, prior to the launch of software application 103. The license file is installed and unlocked with the authentication key. After installing and unlocking the license file, software application 103 is configured based on the license file.

For example, application files 111 include all the components of the software application (i.e. all features across multiple editions). Software package 110 supports multiple license files 112 (i.e. editions). In other words, all the various editions of the software application are included in the same deployment or installation package. The capabilities (i.e. features) of application 103 are configured based on the license file(s) at launch time. Advantageously, rather than generating and deploying multiple software installation packages, this allows for a single deployment package, which only requires a single download and installation by the user.

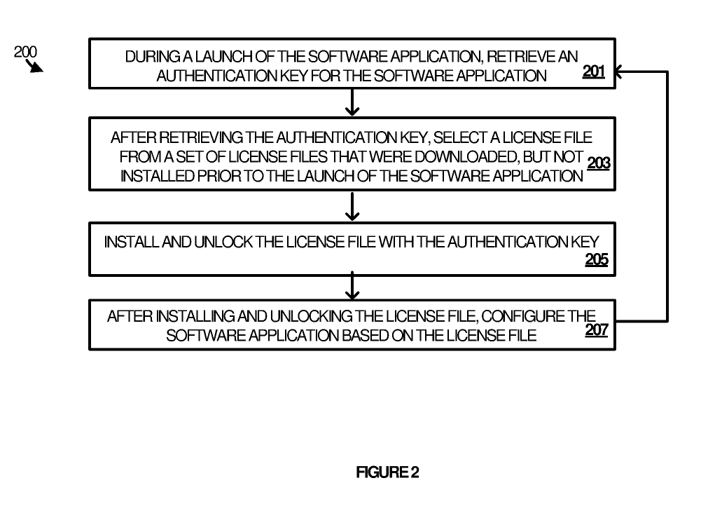

FIG. 2 illustrates at-launch software application configuration process 200. Process 200 may be employed by a start-up module within application 103 to perform at-launch configuration. Some or all of the steps of process 200 may be implemented in program instructions in the context of the component or components of the software application. The program instructions direct start-up module of application 103 to operate as follows, although in some implementations the start-up module may belong to an operating system utility or some other application other than the one being started.

To begin, during a launch of a software application, the application retrieves an authentication key for the software application (step 201). The software application may be launched when a user selects and double-clicks the icon for the software application, for example, or started in some other manner The authentication key may be retrieved from an Online Licensing Service (OLS) in some implementations.

After retrieving the authentication key, the application selects a license file from a set of license files that were downloaded, but not installed prior to the launch of the software application (step 203). For example, a software installation package may include application files and license files. A user may download the software installation package, the application files may be installed, and the license files may be stored in another section of memory. The application may select a license file based on a user login. The application then installs and unlocks the license file with the authentication key (step 205). In some examples, installing the license file means to move the license file into a specified location in memory. The authentication key may comprise a product key (i.e. a 5×5 authentication key) in some implementations.

After installing and unlocking the license file, the application is configured based on the license file (step 207). The software application may be configured with certain features enabled and other features disabled based on the license purchased or otherwise obtained by the user. For example, if the user obtained a student license, features only available on the professional edition would be disabled for the user.

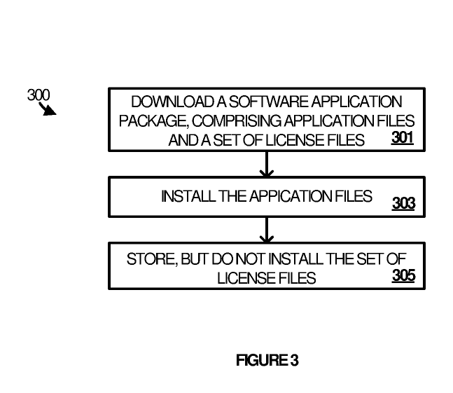

FIG. 3 illustrates the process 300. Process 300 may be employed by computing system 101 prior to process 200. Some or all of the steps of process 300 may be implemented in program instructions in the context of one or more application utilities, such as a download manager and/or an installation manager. The program instructions direct computing system 101 to operate as follows.

To begin, the utility downloads a software application package onto the computing system (step 301). For example, the software application package may comprise the application files and license files for application 103. The software application package may be downloaded from a website over the Internet, from a flash-drive, from a read-only memory device such as a CD of DVD, or obtained in some other manner (e.g. pre-installed). As mentioned, the software package may include application files, which include components of the application components and the corresponding license files. The application files are installed on the computing system (step 303). The license files are stored, but not installed (step 305). In some cases, none of the license files may be installed. In other cases, at least one of the license files is installed at that time.

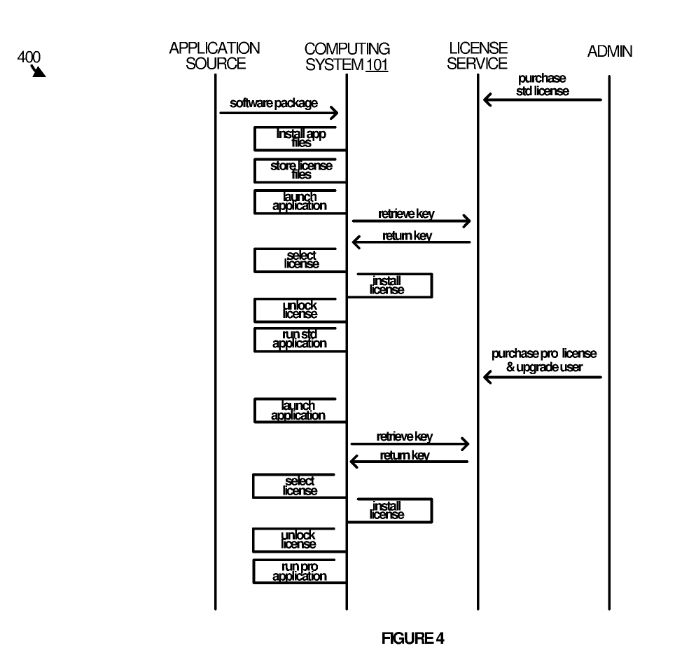

FIG. 4 illustrates sequence diagram 400 illustrating example operations of implementation 100 to perform at-launch configuration of application 103. First, an administrator purchases a standard license for a software application. For example, a user may purchase a home license for a word processing application. Next, a software installation package for the software application is downloaded from an application source onto computing system 101. For example, the application source may be a website, a program disc, a flash-drive, or some other resource.

The software installation package includes application files 111 and license files 112. Application files 111 include all of the components of software application 103 for all editions-not only the components included in the standard edition for which the user obtained a license.

The application files 111 are installed onto computing system 101. License files 112 are stored, but not installed. A user may launch application 103, subsequent to which computing system 101 requests an authentication key for application 103 from a license service. For example, a request may be sent to an online licensing service (OLS) for an authentication key. The license service returns the requested authentication key. In some examples, a 5×5 authentication key is returned.

Computing system 101 selects a license file from license files 112 that were downloaded prior to the launch of application 103, but not installed. For example, the license file may be selected based on user data. The selected license file is installed on computing system 101. For example, the selected license file may be moved into a different location in memory or provided with the proper namespace for installation. The license file is unlocked with the authentication key. After installing and unlocking the license file, software application 103 is configured based on the license file. For example, application 103 is configured for the standard license purchased by the administrator. Computing system 101 runs the standard edition of application 103.

Subsequently, the administrator purchases a professional (pro) license for the user. The user launches another instance of application 103. Computing system 101 requests an authentication key for application 103 from the license service. Computing system 101 selects a license file from license files 112 that were downloaded prior to the launch of application 103, but not installed. For example, the professional license file may be selected based on user data. The professional license file is installed on computing system 101. For example, the selected license file may be moved into a different location in memory or provided with the proper namespace for installation. The license file is unlocked with the authentication key. After installing and unlocking the professional license file, software application 103 is configured based on the license file. For example, application 103 is configured for the professional license purchased by the administrator. Computing system 101 is then able to run the professional edition of application 103.

Advantageously, although the application 103 was upgraded from the standard edition to the professional edition, the software installation package for application 103 was only downloaded and installed once.

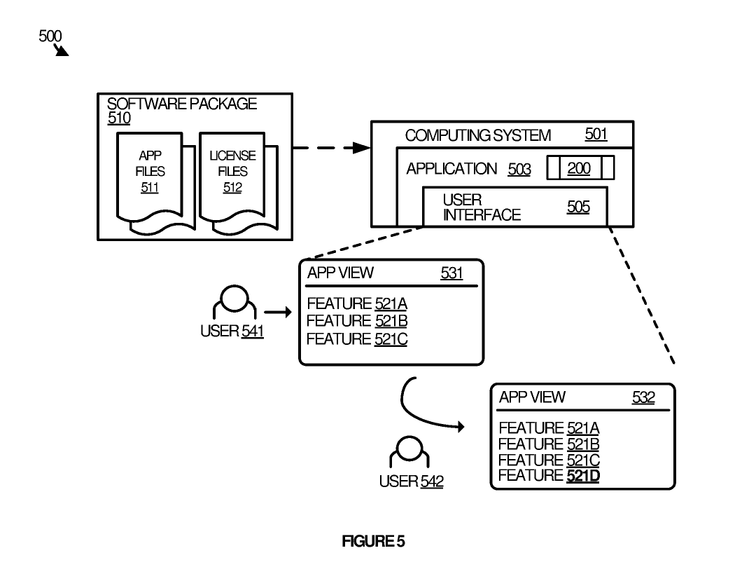

FIG. 5 illustrates an implementation 500 that is representative of at-launch configuration of a software application. Implementation 500 involves software package 510, which includes application files 511 and license files 512 being downloaded onto computing system 501. Software package 510 is the software installation package for application 503. Application files 511 are downloaded and installed onto computing system 501. License files 512 are downloaded, but not installed.

After downloading and installing application files 511, application 503 may be run on computing system 501. When executing, application 503 drives user interface 505 through which users 541-542 may interact with application 503.

User 541 launches one instance of application 503 (app view 531) and user 542 launches another instance of application 503 (app view 532). As shown, in app view 531, application 503 has features 521A-C enabled and in app view 532, application 503 has features 521A-D enabled. User 541 may have purchased the standard edition of application 503, while user 542 purchased the professional edition. Application files 511 include the components for both the standard edition and the professional edition, (e.g. features 521A-D) and the features are enabled/disabled based on the user's license.

In operation, software package 510 is downloaded onto computer system 501. The application files 511 are installed onto computing system 501, and license files 512 are stored, but not installed. User 541 launches an instance of application 503. During the launch of application 503, an authentication key for application 503 is retrieved. After retrieving the authentication key, a license file that corresponds to the license purchased by user 541 is selected from license files 512 that were downloaded, but not installed, prior to the launch of software application 103. For example, user 541 purchased a standard license, so the standard license file is selected for the set of license files. The standard license file is installed and unlocked with the authentication key. After installing and unlocking the license file, software application 503 is configured based on the license file.

User 542 launches a second instance of application 503. During the launch of the second instance of application 503, a second authentication key for application 503 is retrieved. After retrieving the second authentication key, a second license file that corresponds to the license purchased by user 542 is selected from the set of license files 512 that were downloaded, but not installed, prior to the launch of software application 503.

For example, user 542 purchased a professional license, so the professional license file is selected from the set of license files. The professional license file is installed and unlocked with the authentication key. After installing and unlocking the license file, software application 503 is configured based on the license file.

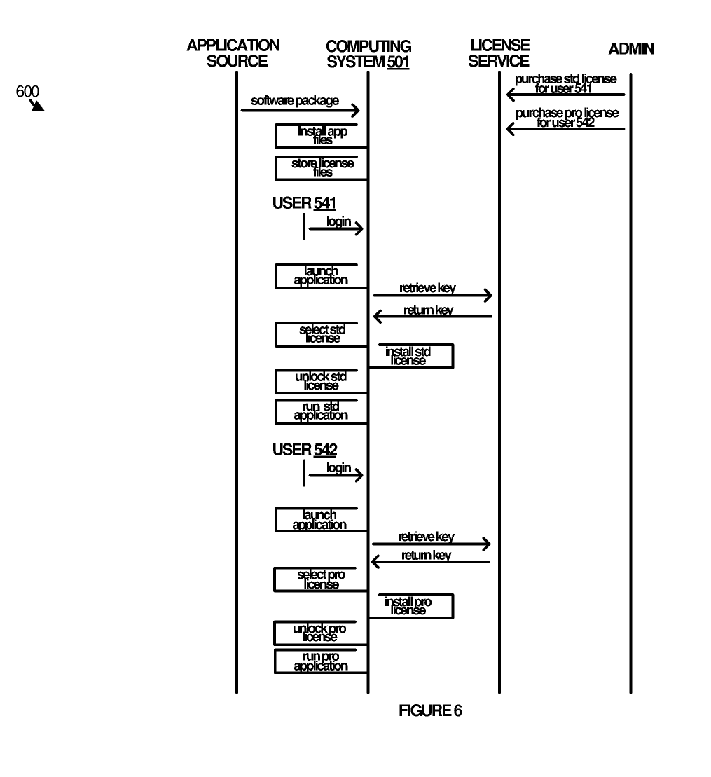

FIG. 6 illustrates sequence diagram 600 illustrating example operations of implementation 500 to perform at-launch configuration of application 503. First, an administrator purchases a standard license for software application 503 for user 541 and a professional license for software application 503 for user 542. Next, a software installation package for software application 503 is downloaded from an application source onto computing system 501. For example, the application source may be a website or a program disc, a server, or some other application source.

The software installation package 510 includes application files 511 and license files 512. Application files 511 include all the components of software application 503 (e.g. components for both the standard and the professional edition).

The application files 511 are installed onto computing system 501. License files 512 are stored, but not installed. User 541 logs-in to computing system 501 and launches an instance of application 503. Computing system 501 requests an authentication key for application 503 from a license service. For example, a request may be sent to an online licensing service for an authentication key. The license service returns the requested authentication key. In some examples, a 5×5 authentication key is returned.

Computing system 501 selects a license file for user 541. The license file is selected from license files 512 that were downloaded prior to the launch of application 503, but not installed. The standard license file is installed on computing system 501. The standard license file is unlocked with the authentication key. After installing and unlocking the standard license file, software application 503 is configured based on the standard license file. Computing system 501 runs the standard edition of application 503.

Subsequently, user 542 logs-in to computing system 501 and launches another instance of application 503. Computing system 501 requests an authentication key for application 503 from the license service. For example, a request may be sent to the online licensing service for an authentication key. The license service returns the requested authentication key. In some examples, a 5×5 authentication key is returned.

Computing system 501 selects a license file for user 542. The license file is selected from license files 512 that were downloaded prior to the launch of application 503, but not installed. The professional license file is installed on computing system 501. The professional license file is unlocked with the authentication key. After installing and unlocking the professional license file, software application 503 is configured based on the professional license file. Computing system 501 runs the professional edition of application 503.

Advantageously, although user 541 and user 542 have different licenses (e.g. different editions of application 503), the invention allows both users to run their purchased editions of application 503 on the same computing system 501 without requiring a re-install of the software application package.

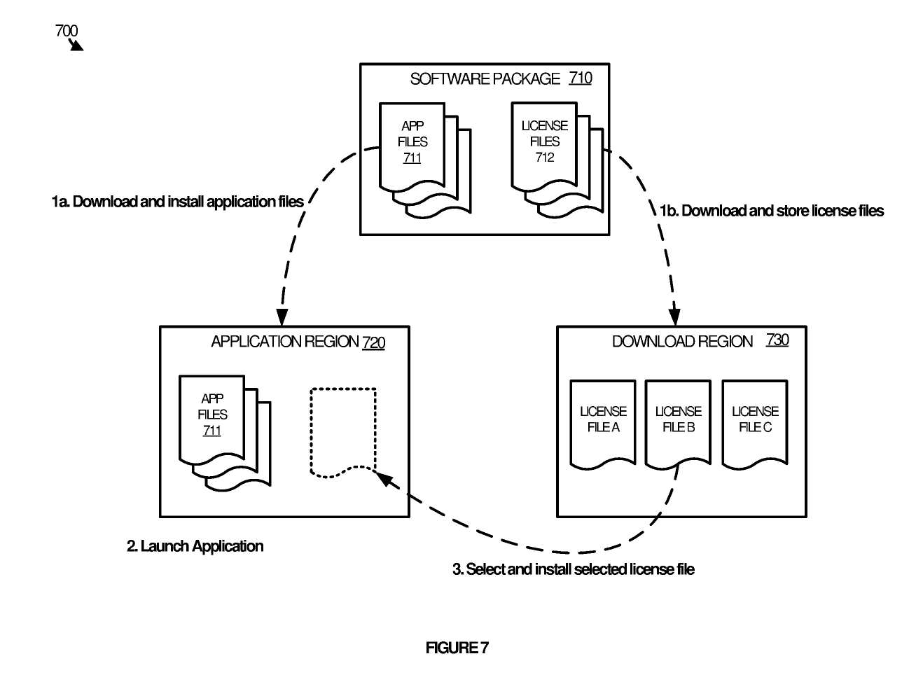

FIG. 7 illustrates operational scenario 700 for an at-launch configuration of a software application. In operation, software package 710 includes application files 711 and license files 712. Application files 711 include all components for multiple versions of the software application. Application files 711 are downloaded and installed into application region 720. Application region 720 may be representative of a location in memory and/or persistent storage. License files 712 are downloaded and stored in download region 730. Download region 730 may be representative of another, different location in memory and/or persistent storage.

The software application is launched, at which time an authentication key for the software application is retrieved. After retrieving the authentication key, a license is selected from license files 712 stored in download region 730. For example, “License File B” is selected and “License File B” is installed. Installing “License File B” may mean moving it into application region 720. For example, moving “License File B” to application region 720 allows “License File B” to be accessible by application files 711.

In some examples, multiple license files may be selected and installed. If multiple license files are selected and installed, the license files may be concatenated to allow the software application to be configured based on all selected license file(s).

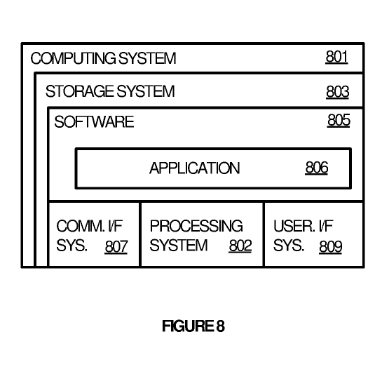

FIG. 8 illustrates computing system 801, which is representative of any system or collection of systems in which the various applications, services, scenarios, and processes disclosed herein may be implemented. Computing system 801 may be employed to perform at-launch configuration of a software application.

Examples of computing system 801 include, but are not limited to, personal computers, mobile phones, tablet computers, desktop computers, laptop computers, wearable computing devices, server computers, blade servers, rack servers, and any other type of computing system (or collection thereof) suitable for carrying out the optimization operations described herein. Such systems may employ one or more virtual machines, containers, or any other type of virtual computing resource in the context of performing at-launch configuration of a software application.

Computing system 801 may be implemented as a single apparatus, system, or device or may be implemented in a distributed manner as multiple apparatuses, systems, or devices. Computing system 801 includes, but is not limited to, processing system 802, storage system 803, software 805, communication interface system 807, and user interface system 809. Processing system 802 is operatively coupled with storage system 803, communication interface system 807, and user interface system 809. In some implementations, user interface system 809 may be omitted. Computing system 801 may include other components omitted for clarity.

Processing system 802 loads and executes software 805 from storage system 803. Software 805 includes application 806 which is representative of the software applications discussed with respect to the preceding FIGS. 1-7, including software application 103 and 503. When executed by processing system 802, software 805 directs processing system 802 to operate as described herein for at least the various processes, operational scenarios, and sequences discussed in the foregoing implementations to perform at-launch configuration of a software application. Computing system 801 may optionally include additional devices, features, or functionality not discussed for purposes of brevity.

Referring still to FIG. 8, processing system 802 may comprise a micro-processor and other circuitry that retrieves and executes software 805 from storage system 803. Processing system 802 may be implemented within a single processing device, but may also be distributed across multiple processing devices or sub-systems that cooperate in executing program instructions. Examples of processing system 802 include general purpose central processing units, application specific processors, and logic devices, as well as any other type of processing device, combinations, or variations thereof.

Storage system 803 may comprise any computer readable storage media readable by processing system 802 and capable of storing software 805. Storage system 803 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

in addition to computer readable storage media, in some implementations storage system 803 may also include computer readable communication media over which at least some of software 805 may be communicated internally or externally. Storage system 803 may be implemented as a single storage device, but may also be implemented across multiple storage devices or sub-systems co-located or distributed relative to each other. Storage system 803 may comprise additional elements, such as a controller, capable of communicating with processing system 802 or possibly other systems.

Software 805 in general, and application 806 in particular, may be implemented in program instructions and among other functions may, when executed by processing system 802, direct processing system 802 to operate as described with respect to the various operational scenarios, sequences, and processes illustrated herein. For example, application 806 may include program instructions for performing at-launch configuration of a software application.

In particular, the program instructions may include various components or modules that cooperate or otherwise interact to carry out the various processes and operational scenarios described herein. The various components or modules may be embodied in compiled or interpreted instructions, or in some other variation or combination of instructions. Software 805 may include additional processes, programs, or components, such as operating system software, virtual machine software, or other application software, in addition to or that include application 806. Software 805 may also comprise firmware or some other form of machine-readable processing instructions executable by processing system 802.

In general, application 806 may, when loaded into processing system 802 and executed, transform a suitable apparatus, system, or device (of which computing system 801 is representative) overall from a general-purpose computing system into a special-purpose computing system customized to perform at-launch configuration of a software application. Indeed, encoding application 806 on storage system 803 may transform the physical structure of storage system 803. The specific transformation of the physical structure may depend on various factors in different implementations of this description.

For example, if the computer readable storage media are implemented as semiconductor-based memory, application 806 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 807 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

User interface system 809 may include a keyboard, a mouse, a voice input device, a touch input device for receiving a touch gesture from a user, a motion input device for detecting non-touch gestures and other motions by a user, and other comparable input devices and associated processing elements capable of receiving user input from a user. Output devices such as a display, speakers, haptic devices, and other types of output devices may also be included in user interface system 809. In some cases, the input and output devices may be combined in a single device, such as a display capable of displaying images and receiving touch gestures. The aforementioned user input and output devices are well known in the art and need not be discussed at length here.

User interface system 809 may also include associated user interface software executable by processing system 802 in support of the various user input and output devices discussed above. Separately or in conjunction with each other and other hardware and software elements, the user interface software and user interface devices may support a graphical user interface, a natural user interface, or any other type of user interface, in which a user interface to an application may be presented (e.g. user interfaces 105 and 405).

Communication between computing system 801 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses, computing backplanes, or any other type of network, combination of network, or variation thereof. The aforementioned communication networks and protocols are well known and need not be discussed at length here. In any of the aforementioned examples in which data, content, or any other type of information is exchanged, the exchange of information may occur in accordance with any of a variety of well-known data transfer protocols.

Certain inventive aspects may be appreciated from the foregoing disclosure, of which the following are various examples.

### EXAMPLE 1

A computing apparatus comprising: one or more computer readable storage media; a processing system operatively coupled with the one or more computer readable storage media; and program instructions stored on the one or more computer readable storage media for operating a software application; wherein the program instructions, when executed by the processing system, direct the processing system to at least: during a launch of the software application, retrieve an authentication key for the software application; after retrieving the authentication key, select a license file from a set of licenses files that were downloaded, but not installed prior to the launch of the software application; install and unlock the license file with the authentication key; and after installing and unlocking the license file, configure the software application based on the license file.

### EXAMPLE 2

The computing apparatus of Example 1 wherein to configure the software application based on the license file, the program instructions direct the processing system to: configure the software application with features enabled based on the license file.

### EXAMPLE 3

The computing apparatus of Examples 1-2 wherein to configure the software application based on the license file, the program instructions direct the processing system to: configure the software application with features disabled based on the license file.

### EXAMPLE 4

The computing apparatus of Examples 1-3 wherein to select the license file from the set of license files that were downloaded, but not installed prior to the launch the software application, the program instructions direct the processing system to: select the license file from the set of license files based on a user's login information.

### EXAMPLE 5

The computing apparatus of Examples 1-4 wherein the program instructions direct the processing system to: during a launch of a second instance the software application, retrieve a second authentication key for the software application; after retrieving the second authentication key, select a second license file from the set of licenses files; install and unlock the second license file with the second authentication key; and after installing and unlocking the second license file, configure the software application based on the second license file.

### EXAMPLE 6

The computing apparatus of Examples 1-5 wherein the program instructions direct the processing system to: download a software application package that comprises the software application and the set of license files; and install the software application, and store bot not install the set of license files.

### EXAMPLE 7

The computing apparatus of Examples 1-6 wherein the software application comprises a business application.

### EXAMPLE 8

The computing apparatus of Examples 1-7 wherein the software application comprises a database application.

### EXAMPLE 9

A method for performing at-launch configuration of a software application, the method comprising: during a launch of the software application, retrieving an authentication key for the software application; after retrieving the authentication key, selecting a license file from a set of licenses files that were downloaded, but not installed prior to the launch of the software application; installing and unlocking the license file with the authentication key; and after installing and unlocking the license file, configuring the software application based on the license file.

### EXAMPLE 10

The method of Examples 9 wherein configuring the software application based on the license file, comprises configuring the software application with features enabled based on the license file.

### EXAMPLE 11

The method of Examples 9-10 wherein configuring the software application based on the license file, comprises configuring the software application with features disabled based on the license file.

### EXAMPLE 12

The method of Examples 9-11 wherein selecting the license file from the set of license files that were downloaded, but not installed prior to the launch the software application, comprises selecting the license file from the set of license files based on a user's login information.

### EXAMPLE 13

The method of Examples 9-12 further comprising: during a launch of a second instance the software application, retrieving a second authentication key for the software application; after retrieving the second authentication key, selecting a second license file from the set of licenses files; installing and unlocking the second license file with the second authentication key; and after installing and unlocking the second license file, configuring the software application based on the second license file.

### EXAMPLE 14

The method of Examples 9-13 further comprising: downloading a software application package that comprises the software application and the set of the license files; and installing the software application, and storing bot not install the set of license files.

### EXAMPLE 15

The method of Examples 9-14 wherein the software application comprises a business application.

### EXAMPLE 16

The method of Examples 9-15 wherein the software application comprises a database application.

### EXAMPLE 17

One or more computer readable storage media having program instructions stored thereon to perform at-launch configuration of a software application, wherein the program instructions, when executed by a processing system, direct the processing system to at least: during a launch of the software application, retrieve an authentication key for the software application; after retrieving the authentication key, select a license file from a set of licenses files that were downloaded, but not installed prior to the launch of the software application; install and unlock the license file with the authentication key; and after installing and unlocking the license file, configure the software application based on the license file.

### EXAMPLE 18

The one or more computer readable storage media of Example 17 wherein to configure the software application based on the license file, the program instructions direct the processing system to: configure the software application with features enabled based on the license file.

### EXAMPLE 19

The one or more computer readable storage media of Examples 17-18 wherein to configure the software application based on the license file, the program instructions direct the processing system to: configure the software application with features disabled based on the license file.

### EXAMPLE 20

The one or more computer readable storage media of Examples 17-19 wherein the program instructions direct the processing system to: during a launch of a second instance the software application, retrieve a second authentication key for the software application; after retrieving the second authentication key, select a second license file from the set of licenses files; install and unlock the second license file with the second authentication key; and after installing and unlocking the second license file, configure the software application based on the second license file.

The functional block diagrams, operational scenarios and sequences, and flow diagrams provided in the Figures are representative of exemplary systems, environments, and methodologies for performing novel aspects of the disclosure. While, for purposes of simplicity of explanation, methods included herein may be in the form of a functional diagram, operational scenario or sequence, or flow diagram, and may be described as a series of acts, it is to be understood and appreciated that the methods are not limited by the order of acts, as some acts may, in accordance therewith, occur in a different order and/or concurrently with other acts from that shown and described herein. For example, those skilled in the art will understand and appreciate that a method could alternatively be represented as a series of interrelated states or events, such as in a state diagram. Moreover, not all acts illustrated in a methodology may be required for a novel implementation.

The descriptions and figures included herein depict specific implementations to teach those skilled in the art how to make and use the best option. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

1. A computing apparatus comprising:
one or more computer readable storage media;
a processing system operatively coupled with the one or more computer readable storage media; and
program instructions stored on the one or more computer readable storage media for operating a software application that, when executed by a processing system, direct the processing system to at least:
during a launch of the software application, retrieve an authentication key for the software application;
after retrieving the authentication key, select a license file from a set of license files that were downloaded, but not installed prior to the launch the software application;
install and unlock the license file with the authentication key; and
after installing and unlocking the license file, configure the software application based on the license file.

2. The computing apparatus of claim 1 wherein the program instructions direct the processing system to configure the software application with features enabled based on the license file.

3. The computing apparatus of claim 1 wherein the program instructions direct the processing system to configure the software application with features disabled based on the license file.

4. The computing apparatus of claim 1 wherein the program instructions direct the processing system to select the license file from the set of license files based on a user's login information.

5. The computing apparatus of claim 1 wherein the program instructions direct the processing system to:
during a launch of a second instance of the software application, retrieve a second authentication key for the software application;
after retrieving the second authentication key, select a second license file from the set of license files;
install and unlock the second license file with the second authentication key; and
after installing and unlocking second the license file, configure the second instance of the software application based on the second license file.

6. The computing apparatus of claim 1 wherein the program instructions direct the processing system to:
download a software application package that comprises the software application and the set of license files; and
install the software application, and store but not install the set of license files.

7. The computing apparatus of claim 1 wherein the software application comprises a business application.

8. The computing apparatus of claim 1 wherein the software application comprises a database application.

9. A method for performing at-launch configuration of a software application, the method comprising:
during launch of the software application, retrieving an authentication key for the software application;
after retrieving the authentication key, selecting a license file from a set of license files that were downloaded, but not installed prior to launching the software application;
installing and unlocking the license file with the authentication key; and
after installing and unlocking the license file, configuring the software application based on the license file.

10. The method of claim 9 wherein configuring the software application based on the license file comprises configuring the software application with features enabled based on the license file.

11. The method of claim 9 wherein configuring the software application based on the license file comprises configuring the software application with features disabled based on the license file.

12. The method of claim 9 wherein selecting the license file from the set of license files comprises selecting the license file based on a user's login information.

13. The method of claim 9, further comprising:
during a launch of a second instance of the software application, retrieving a second authentication key for the software application;
after retrieving the second authentication key, selecting a second license file from the set of license files;
installing and unlocking the second license file with the second authentication key; and
after installing and unlocking the second license file, configuring the second instance of the software application based on the second license file.

14. The method of claim 9, further comprising:
downloading a software application package that comprises the software application and the set of license files; and
installing the software application, and storing but not installing the set of license files.

15. The method of claim 9 wherein the software application comprises a business application.

16. The method of claim 9 wherein the software application comprises a database application.

17. One or more computer readable storage media having program instructions stored thereon for performing at-launch configuration of a software application based on licenses, wherein the program instructions, when executed by a processing system, direct the processing system to at least:
during a launch of the software application, retrieve an authentication key for the software application;
after retrieving the authentication key, select a license file from a set of license files that were downloaded, but not installed prior to launching the software application;
install and unlock the license file with the authentication key; and
after installing and unlocking the license file, configure the software application based on the license file.

18. The one or more computer readable storage media of claim 17 wherein the program instructions further direct the processing system to:
during a launch of a second instance of the software application, retrieve a second authentication key for the software application;
after retrieving the second authentication key, select a second license file from the set of license files;
install and unlock the second license file with the second authentication key; and
after installing and unlocking the second license file, configure the second instance of the software application based on the second license file.

19. The one or more computer readable storage media of claim 17 wherein the program instructions direct the processing system to configure the software application with features enabled based on the license file.

20. The one or more computer readable storage media of claim 17 wherein the program instructions direct the processing system to configure the software application with features disabled based on the license file.
